(19) United States
(12) Patent Application Publication
(10) Pub. No.: US 2023/0231714 A1
(43) Pub. Date: Jul. 20, 2023

(54) METHOD AND SYSTEM FOR A VERIFIABLE IDENTITY BASED ENCRYPTION (VIBE) USING CERTIFICATE-LESS AUTHENTICATION ENCRYPTION (CLAE)

(71) Applicant: VIBE Cybersecurity Inc., Panama City (PA)

(72) Inventor: Paul GERMOUTY, Limoges (FR)

(21) Appl. No.: 18/002,492

(22) PCT Filed: Jul. 7, 2020
(86) PCT No.: PCT/IB2020/000499

§ 371 Date: Dec. 20, 2022

(51) Int. Cl. H04L 9/32; H04L 9/00; H04L 9/06; H04L 9/30

(52) U.S. Cl. CPC H04L 9/321; H04L 9/006; H04L 9/0618; H04L 9/3073; H04L 9/0643

(57) ABSTRACT

Solutions of verifying a plurality of public parameters from a Trusted Centre (TC) in an identity-based encryption and signature system prior to encrypting a plaintext message by a sender having a sender identity string. The method may include identification of the Trusted Centre by a TC identity string, the Trusted Centre having a master public encryption key based on the TC identity string; determination if the sender has a sender private key and the public parameters for the Trusted Centre including the master public key of the Trusted Centre and a bilinear map; and verification of the public parameters using the TC identity string prior to encrypting the plaintext message into a ciphertext by comparing values of the bilinear map calculated with variables comprising the sender private key and the master public key. The ciphertext may include an authentication component for authenticating the sender once the ciphertext is received and decrypted by the recipient using the identity string of the sender and the private key of the recipient. Enables a signature scheme from the same parameters and private keys, the signature is forged using the private key of the signer, the message and the public parameters, the verification is done using the public parameters, the identity of the signer, the signature and the message.

### FIELD

This invention relates to a certificate-less authenticated encryption scheme and, in particular, an encryption scheme using identity strings to provide identity-based encryption.

### BACKGROUND

Cryptographic encryption algorithms add confidentiality to sensitive data that is transmitted over an insecure channel. The data is protected, as the encryption algorithm transforms the data from plaintext into ciphertext prior to transmission. The recipient of the encrypted data is only able to decrypt the ciphertext and retrieve the plaintext from the received transmission, if the recipient is able to reverse the encryption algorithm. If the encryption and decryption algorithms share the same key, the cryptosystem is known as “symmetric” and the algorithms are called symmetric-key algorithms If the key in the encryption algorithm is different than the key in the decryption algorithm, the cryptosystem is known as “asymmetric” and the algorithms are called asymmetric-key algorithms

In asymmetric-key algorithms, the key used for encryption (i.e. the “public key”) is publicly known, as everyone should be able to use it to encrypt sensitive data. However, the key used in the decryption (i.e. the “private key”) is only known to the intended receiver of the encrypted data and is protected such that the intended receiver is the only entity able to decrypt the encrypted message. An asymmetric cryptosystem is commonly referred to as a Public Key Cryptosystem (PKC).

In a PKC, the public key and the private key are built such that knowledge of the public key does not reveal or lead to the private key. In other words, the public key can be made public such that anyone can encrypt data for a specific recipient, but only the specific recipient has knowledge of the private key and is able to utilize the private key to decrypt and retrieve the data. Since the public keys in the PKC are publicly known, they are considered insensitive and can be transmitted over any insecure, public channel However, the main challenge with the PKC is to trust whether an available public key is actually associated with the intended recipient. In other words, if a different public key (i.e. a wrong or modified public key) is used by mistake or by fraud, the overall security achieved by utilizing encryption is compromised. The security of the encryption in a Public Key Cryptosystem therefore relies on correctly distributing the public keys that belong to or are associated with the intended recipients of the encrypted message. Accordingly, it is necessary to verify the public keys before encrypting sensitive data with a public key in a PKC.

Since large systems are dynamic and new members join or leave the system at all times, public keys are constantly issued and/or revoked. At the time of registration (setup), a new member is assigned a new set of public/private keys and all the other existing members are notified of the new public key before they can securely communicate with the new member, using the new public key generated.

In the PKC, there are two mechanisms for generating and distributing the public keys throughout the system. In the first mechanism, the public keys are generated by a Trusted Centre, which would then distribute them remotely over a secure channel to the users in the system. The second mechanism is for a sender to generate the public key locally for every recipient. In this way, the Trusted Centre is not required to first generate a private key for every recipient and then distribute these generated public keys remotely over a secure channel to every sender. In both cases a certificate is used to prove the link between a public key and a user owning the corresponding private key.

Generating public keys locally is superior to relying on a Trusted Centre to provide the public keys. When the public encryption keys are generated locally, the latency of encryption is reduced in that it is no longer necessary to retrieve a certificate from a remote server.

Traditionally in the PKC, public keys are generated by a Trusted Centre (certificate authority) guaranteeing that a public key belongs to a certain recipient. The certificate authority is a trustworthy entity that distributes the certificates throughout the PKC. In a typical PKC, the Trusted Centre is operable to produce an X.509 certificate that includes the public key for a recipient as well as other ancillary data. The Trusted Centre then digitally signs the provided certificate, in order for the sender to verify the authenticity of the provided certificate and the corresponding public key. Nevertheless, distributing and managing the public key certificates in a large system is a challenging task, as the certificates have to be protected from tampering over insecure channels during transmission or when received at the sender's local machine.

An alternate approach to public key encryption is to self-generate the public parameters that would be used to encrypt sensitive data using the recipient's known identity, such as a phone number, email address or username. Boneh and Franklin have introduced an Identity-Based Encryption (IBE) scheme in which the identity of the recipient is used in the encryption, such as described in Dan Boneh and Matthew Franklin, “Identity-Based Encryption from the Weil Pairing” SIAM Journal of Computing, 32(3):586-615, 2003 and U.S. Pat. No. 7,113,594 B2, the contents of which are hereby incorporated by reference in their entirety. In their setup, every user is given a private key, but the encryption key is constructed using the identity of the recipient and the Trusted Centre's master public key. Their system removes the need to contact the Trusted Centre (certificate authority) to retrieve the public key of a recipient. However, in their system, the public key of the Trusted Centre (P_{Pub}) has to be strictly protected. If a different public key is used in the encryption by mistake or fraud, the security of the encryption is entirely compromised.

It should be noted that the entire security of their scheme relies on the security of the public key of the Trusted Centre, which is publicly known and therefore widely available. If an adversary can change the public parameter(s) of the Trusted Centre either by accessing the local storage of Trusted Centre's public key or by sending a different public key via a man-in-the-middle attack, the security of the encryption system is compromised.

### SUMMARY

The present invention is directed to provide an improved certificate-less authenticated encryption (CLAE) method and an authentication system using identity-based encryption, thereafter, called Verifiable Identity-Based Encryption (VIBE).

It is an object of the present invention to configure a PKC system which eliminates the need for distributing and managing public keys throughout the system. Instead, the public keys are generated and verified locally. Once the system is initialized, any entity in the system can self-generate the public key of any other entities and encrypt sensitive data by using the recipient's identity, such as a phone number, email address or username. Only the true recipient is then able to decrypt and retrieve the sensitive data using a private key known only to the recipient and obtained from one or plural Trusted Centers.

One of the many security challenges in the PKC systems is protecting the public key certificates from tampering and securely distributing them throughout the system. Boneh and Franklin, as discussed above, proposed an IBE scheme in which the public identity of users is used to generate the encryption keys. However, the same problems occur with the public key of the Trusted Centre (i.e. the “key generator”, according to Boneh and Franklin) If P_{Pub} and P are replaced fraudulently, the fraudster can easily access the encrypted messages. This attack is possible since P_{Pub} and P in the Boneh and Franklin setup are publicly known and widely available. Therefore, the public keys are not protected at all or they are less protected throughout the system than the private keys or the secret master key. Furthermore, the public parameters are broadcast throughout the system via a public, insecure channel. Therefore, an adversary may try to change the values of the public parameters called P_{Pub} and P in the encryption algorithm.

As described in the prior art, a fraudster can substitute the public parameter P_{Pub} (also called master public Key) with any other point, such as xP where x is a random number known to the fraudster and P is a point on the elliptic curve. In this case the adversary can easily find the “session key” and reverse the encryption of the plaintext message M. This is further shown as follows: as described by Boneh and Franklin in their original paper, using their notations, we have a session key of the form e(Q_{I}, P_{Pub})^{r}. If the fraudster replaces the public parameter as described above, we now have the session key equals to e(Q₁, xP)^{r}. Thus, anyone knowing x (e.g. the fraudster) is able to compute a private key for the new public parameters by computing xQ_{I} (Q_{I} as described in the paper of Boneh and Franklin).

In contrast, the VIBE scheme according to the present invention allows the sender to locally verify the public keys (i.e. P_{Pub}) of the server before encrypting the message. In other words, the sender is operable to verify the Trusted Centre (TC) before encrypting a message, thereby ensuring that the public parameters have not been modified. The point of trust in the VIBE scheme of the present invention is established from the public identity of the server (e.g. “abc.com”) and, unlike the prior art, it is not a fixed parameter that can be altered.

In one aspect of the present invention, a new VIBE framework has been designed that uses the identity of the recipient to remove the need for public key certificates. Instead of using a predetermined parameter to generate the public/private encryption key, the user incorporates the identity of the Trusted Centre as well as the identity of the recipient. In this manner, greater flexibility is provided in generating the encryption keys, as the user can arbitrarily choose any Trusted Centre using its own identity and can be assured that its selection will be enforced on the recipient. For instance, the user might want to send an encrypted email from an “abc.com” account to someone with an “xyz.com” account. In this case, the user can choose either “abc.com” or “xyz.com” simply by using the Trusted Centre's identity in the encryption process. The recipient is then forced to verify itself to the Trusted Centre chosen by the sender. Such a system may also allow the sender of an encrypted message to verify one or more of the public parameters to ensure that they have not been tampered with.

In one aspect, the present invention resides in a method of sending an encrypted message by a sender having a sender identity string Id_{Sender} to a recipient over a network using identity-based encryption, the method may include identifying a Trusted Centre (TC) by a TC identity string (Id_{TC}). Furthermore, the method may include determining if the sender has a sender private key Prv_{Sender} and a plurality of public parameters (PK) for the chosen Trusted Centre (TC), the public parameters (PK) including the identity-based public encryption key of the Trusted Centre g_{Pub} and a bilinear map (e). Furthermore, the method may include verifying the public parameters (PK) of the Trusted Centre (TC) using the TC identity string Id_{TC} prior to encrypting a plaintext message. Furthermore, the method may include encrypting the plaintext message (M) as ciphertext (using the identity of the recipient Id_{Recipient}, the public parameters PK, the identity of the TC (Id_{TC}) and a random symmetric encryption key (Σ). Finally, the method may include transmitting the ciphertext (C) to the recipient over the network.

In another aspect, the present invention resides in a method for using verifiable identity-based encryption (VIBE) in a network system between a sender having a sender identity string Id_{Sender} and a recipient having a recipient Identity string Id_{Recipient}, the method may include at the sender: identifying a Trusted Centre (TC) by using the TC identity string Id_{TC} and the method previously mentioned, committing its sender private key Prv_{Sender}, the identity of the recipient Id_{Recipient}, the pairing (e) and the message (M). The message will be encrypted and then an authentication of the sender on this message will be produced. Both will be sent over the network. Furthermore, the method may include at the recipient: receiving the ciphertext (from the sender over the network), decrypting the message using the recipient private key Prv_{Recipient} and the ciphertext C, verifying the authentication using the message decrypted (M), the identity of the sender Id_{Sender} and the private key of the recipient Prv_{Recipient}.

In another aspect, the present invention resides in a method of verifying a plurality of public parameters (PK) from a Trusted Centre (TC) in an identity-based encryption system prior to encrypting a plaintext message (M) by a user with identity string (Id). The method may include identifying the Trusted Centre (TC) by a TC identity string Id_{TC}. Furthermore, the method may include verifying the public parameters (PK) by comparing computations of pairings involving the identity of the Trusted Centre (Id_{TC}), the identity of the user (Id), the private key of the user (Prv_{Id}) and the public parameters (PK). Note that Id stands for a unique identifier of an entity, it can later be the recipient, sender or trusted centre identity depending on its role during the exchange.

In another aspect, the present invention resides in a method for signing a plaintext message (M) or a ciphertext (C) using the already established public parameters (PK) of VIBE. The method includes the use of the private key for the sender (Prv_{Sender}) (the signer) while the recipient (the verifier) uses the public parameters (PK) and the identity of the sender (Id_{Sender}) to verify the validity of the signature. This signature scheme inside VIBE shall thereafter be called VIBS (VIBS: Verifiable Identity-Based Signature).

In another aspect, the present invention resides in a system for sending an encrypted message over a network using identity-based encryption. The system may include: a Trusted Centre (TC) having a TC identity string (Id_{TC}), sender having a sender identity string (Id_{Sender}), and a recipient having a recipient identity string (Id_{Recipient}). The Trusted Centre (TC) may include a first memory and one or more processors configured for:
generating a plurality of public parameters (TC) and a secret master key (s) from a security parameter (□), the public parameters (PK) including a bilinear map (e) and a master public key of the Trusted Centre (g_{Pub}) based on the TC identity string (Id_{TC});
receiving a request from a requestor, if the request from the requestor contains an identifier (Id) identifying the requestor, generating a private key (Prv) based on the Identifier (Id) and the secret master key (s) and transmitting the private key (Prv) to the requestor over the network system, and if the request from the requestor includes a request for the public parameters (PK);
transmitting the public parameters (PK) to the requestor over the network system.

The sender may include a second memory and one or more processors configured for:
identifying the Trusted Centre (TC) by the TC identity string (Id_{TC});
determining if the sender has a sender private key Prv_{Sender} and the public parameters (PK) for the Trusted Centre (TC);
verifying the public parameters (PK) of the Trusted Centre (TC) using the TC identity string (Id_{TC}) prior to encrypting a plaintext message (M); identifying the recipient by the recipient identity string (Id_{Recipient});
encrypting the plaintext message (M) as ciphertext (C) using the public parameters (PK), a random symmetric key (Σ) and the identity string of the recipient (Id_{Recipient}), the ciphertext (C) including the encrypted message;
transmitting the ciphertext (C) to the recipient over the network.

The recipient may include a third memory and one or more processors configured for:
receiving the ciphertext (C) from the sender over the network system;
determining if the recipient has a recipient private key (Prv_{Recipient}) and the public parameters (PK) for the Trusted Centre (TC);
decrypting the ciphertext (C) to obtain the plaintext message (M) using the public parameters (PK), and the recipient private key (Prv_{Recipient}).

In another aspect, the present invention resides in a computer program product comprising a computer readable memory storing computer executable instructions thereon that, when executed by a computer, perform the method of: identifying a Trusted Centre (TC) by an identity string (Id_{TC}), the Trusted Centre having a master public key g_{Pub} based on the TC identity string (Id_{TC}); determining if a sender has a sender private key (Prv_{Sender}) and a plurality of public parameters (PK) for the Trusted Centre (TC), the public parameters (PK) including the master public key of the Trusted Centre (g_{Pub}) and a bilinear map (e); verifying the public parameters (PK) of the Trusted Centre (TC) using the TC identity string (Id_{TC}) prior to encrypting a plaintext message (M); identifying a recipient by a recipient identity string (Id_{Recipient}), encrypting the plaintext message (M) as ciphertext (C) using the public parameters (PK), a random symmetric key (Σ) and the identity string of the recipient (Id_{Recipient}), the ciphertext (C) including an encrypted message based on the plaintext message (M) and transmitting the ciphertext (C) to the recipient over a network.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows a network system in accordance with an embodiment of the present invention;

FIG. 2 shows a flowchart illustrating a method for sending an encrypted message in accordance with an embodiment of the present invention;

FIG. 3 shows a plurality of users in a network registering with the Trusted Centre in accordance with an embodiment of the present invention;

FIG. 4 shows a flowchart for a user labeled “Identity String” registering with the Trusted Centre in accordance with an embodiment of the present invention;

FIG. 5 shows a user labeled “User A” transmitting an encrypted message to a user labeled “User B” in a network with certificate-less authenticated encryption using identity-based encryption in accordance with an embodiment of the present invention;

FIG. 6 shows a flowchart for a user labeled “User A” encrypting a message to a user labeled “User B” in accordance with an embodiment of the present invention;

FIG. 7 shows a flowchart for a user labeled “User A” determining whether to get the public key for the Trusted Centre in accordance with an embodiment of the present invention;

FIG. 8 shows a flowchart for a user labeled “User B” decrypting the message from a user labeled “User A” in accordance with an embodiment of the present invention;

FIG. 9 shows a flowchart for a user labeled “User B” determining whether to get its private key from the Trusted Centre in accordance with an embodiment of the present invention; and

FIG. 10 shows a flowchart for a user labeled “User A” determining whether to get its private key from two different Trusted Centers disabling key escrow in accordance with an embodiment of the present invention.

### DETAILED DESCRIPTION

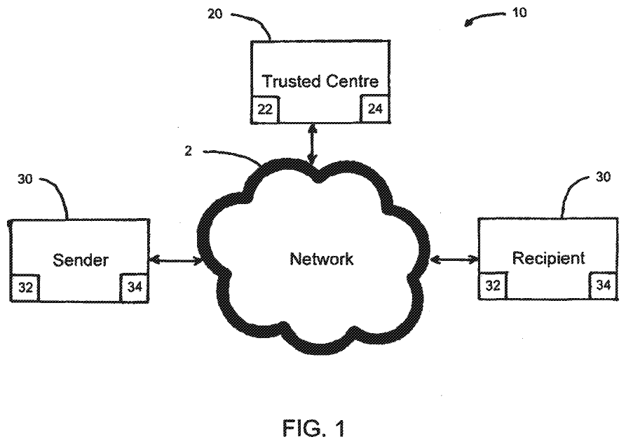

A network system 10 in accordance with an embodiment of the present invention is shown in FIG. 1. The network system 10 includes a Trusted Centre 20, a user 30 labeled as “Sender” and a user 30 labeled as “Recipient” connected over a network 2, such as an intranet, the internet, and/or the like. While the two users 30 may be labeled differently, it should be understood that the labels are arbitrary and may change based on the direction an encrypted message is being sent. A “Sender” is a user 30 operable to package a plaintext message as an encrypted message for transmission and a “Recipient” is a user 30 operable to receive the encrypted message from the “Sender”. Upon a response to an encrypted message, the “Recipient” may become the “Sender”, and vice versa.

Each of the users 30 labeled “Sender” respectively “Recipient” are configured with a memory 32 and one or more processors 34. It should be understood that any additional hardware as known to those skilled in the art may be included, such as dedicated circuits, a field programmable gate array (FPGA), and/or the like. Each of the users 30 may exist on separate computers and/or mobile devices incorporating the necessary operating system, software and/or browsers as known to those skilled in the art.

Similarly, the Trusted Centre 20 may exist as a dedicated server or as part of a distributed network having memory 22 and one or more processors 24. The Trusted Centre 20 may also include additional hardware and/or software components as known the art, such as firewalls and/or associated security mechanisms. The Trusted Centre 20 is connected to the “Sender” and “Recipient” over network 2.

In operation, the network system 10 in accordance with the present invention is operable to transmit information from the “Sender” to the “Recipient” using verifiable identity based encryption (VIBE) scheme. Each of the users 30 is operable to communicate with the Trusted Centre 20 to obtain a respective private key (Prv) and a plurality of public parameters (PK). The public parameters (PK) are specific to the Trusted Centre, which includes a master public key of the Trusted Centre (g_{Pub}) Once these parameters (i.e. Prv and PK) have been obtained by the respective “Sender” and “Recipient”, the sender and recipient are operable to communicate independent of the Trusted Centre 20 over a secure channel by encrypting the message using the identity string (Id_{Recipient}) associated with the recipient. Furthermore, prior to encrypting a message, the sender is operable to verify the public parameters (PK) of the Trusted Centre (TC) using the Trusted Centre identity string (Id_{TC}), which is known to the sender, to ensure that the public parameters (PK) have not been modified.

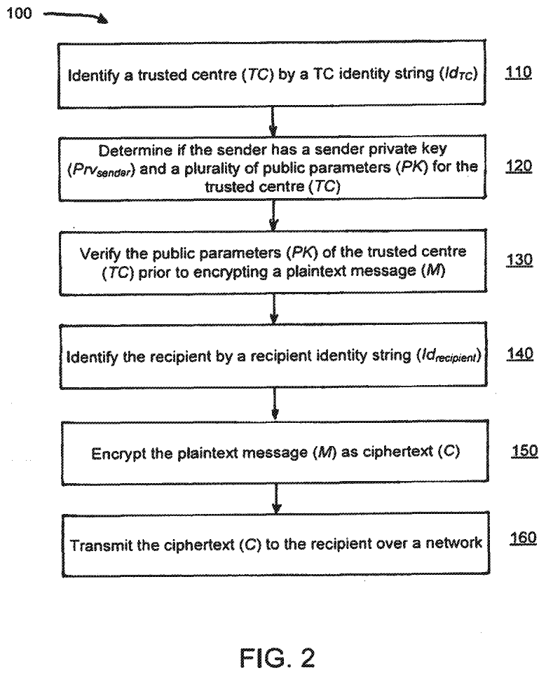

The VIBE scheme according to the present invention is based on identity-based encryption (IBE) and, as shown in the flowchart 100 of a preferred embodiment as seen in FIG. 2, generally operates as follows:
a) In step 110, the user 30 (i.e. “Sender”) identifies a Trusted Centre (TC) by a TC identity string ((Id_{TC}) i.e. “xyz.com” or “name of TC”).
b) In step 120, the “Sender” determines if it has a sender private key (Prv_{Sender}) and a plurality of public parameters (PK) associated with or generated by the Trusted Centre (TC).
c) In step 130, the “Sender” verifies the public parameters (PK) of the Trusted Centre (TC) prior to encrypting a plaintext message (M). The verification process relies on the properties of the public parameters (PK) and sender private key (Prv_{Sender}), both generated by the Trusted Centre (TC), and the known TC identity string (Id_{TC}) and the sender identity string (Id_{Sender}), the verification process relies on the mathematical properties of the bilinear map (e), which forms part of the public parameters, as further discussed below.
d) In step 140, the “Sender” identifies the user 30 (i.e. “Recipient”) to receive the plaintext message (M) by a recipient identity string (Id_{Recipient}). The recipient identity string may be an email address, a phone number, a name, and/or the like.
e) In step 150, the “Sender” encrypts the plaintext message (M) as ciphertext (C) using the identity of the recipient (Id_{Recipient}) and the public parameters (PK). The ciphertext (C) includes the encrypted message, as well as ancillary information necessary for decrypting the message. Additional authentication information may also be appended to the ciphertext (C); this additional piece is computed using the identity of the recipient (Id_{Recipient}) and the private key of the sender (Prv_{Sender}).
f) In step 160, the “Sender” transmits the ciphertext (C) to the “Recipient” over the network. As the message is encrypted, the message may be sent over an unsecured channel. A user will require the recipient private key (Prv_{Recipient}) and the public parameters for the Trusted Centre (PK) to decrypt and be able to read the plaintext message (M).

In this manner, the “Sender” is able to send a plaintext message (M) as an encrypted message to the “Recipient” without accessing the Trusted Centre (TC), as long as the “Sender” has the required public parameters (PK) and its own sender private key (Prv_{Sender}). Furthermore, with the public parameters (PK) and its own sender private key (Prv_{Sender}), the “Sender” is able to verify that the public parameters (PK) have not been compromised. In this manner, the “Sender” is operable to ensure that only the “Recipient” having the recipient private key (Prv_{Recipient}) will be able to decrypt the ciphertext (C).

To implement the VIBE scheme according to the present invention, and the method of the preferred embodiment of the present invention discussed above, four major algorithms are utilized. It should be understood that additional algorithms, application programming interfaces (APIs), methods, and/or functions will be known and/or implemented by those skilled in the art to provide common functions and operations necessary to implement the network system according to the present invention. The four major algorithms in accordance with a preferred embodiment include:
Setup(λ): This algorithm is run by the Trusted Centre 20 (i.e. system administrator) which provides the encryption/decryption services. It takes as inputs the security parameter (λ) and outputs the public parameters (PK) and the secret master key (s) of the Trusted Centre (TC).
KeyGen(Id,s): This algorithm is also run by the Trusted Centre 20 (i.e. administrator) which distributes the private keys (Prv) throughout the system. It takes as inputs an identity string (Id), which may be received from a user 30, and the secret master key (s) from the administrator. It outputs a private key (Prv_{Id}) that will be used for decryption in the Auth-Decrypt( ) algorithm, but which may also be incorporated into the Verifi-Encrypt( ) algorithm to allow for the authentication of a sent message. While the KeyGen( ) algorithm is run by the Trusted Centre 20, it may be run on behalf of a user 30 which has provided its identity string (Id) to the Trusted Centre (TC).
Verifi-Encrypt(Id,PK,M,Prv_{Sender}): This algorithm is run independently by individual users 30 who wish to encrypt sensitive data (i.e. the “Sender”). It takes as inputs the identity string of the recipient ((Id), or more specifically, (Id_{Recipient})), the set of public parameters (PK), the plaintext message (M) and the private key of the sender (Prv_{Sender}) The algorithm first verifies whether the public parameters (PK) are genuine under the given administrative network for the specific Trusted Centre 20 and then outputs the ciphertext message (C) where C=(V,U,W,Y) and where V, U, and W are parameters that are necessary to decrypt and recover the plaintext message (M), and Y is a parameter which may be used by the recipient to authenticate the sender.
Auth-Decrypt(Prv_{Id},PK,Id_{Sender},C): This algorithm is run independently by individual users 30 who are recipients of the ciphertext (C) and wish to decrypt and access the plaintext message (M) from the ciphertext (C). The algorithm takes as inputs the private key of the recipient ((Prv_{Id}), or more specifically, (Prv_{Recipient})), the public parameters (PK), the identity of the Sender (Id_{Sender}) and the ciphertext message (C). If the recipient has the proper private key (Prv_{Id}) under the same administrative network associated with identity string of the recipient (Id), the algorithm outputs the plaintext message (M).

The internal structure of each of the four-mentioned algorithms in accordance with a preferred embodiment of the present invention will be further discussed below, including the mathematical basis which may provide the functionality of the mentioned algorithms

### Bilinear Pairings

The VIBE scheme according to the present invention is based on bilinear pairings. A bilinear pairing is formally defined as follows:

Let (G₁,·), (G₂,·) and (G_{T},·) be groups, with G₁ and G₂ prime order groups, let g₁ be a generator of G₁ and g₂ be a generator of G₂. A bilinear map is an efficiently computable application from (G₁×G₂) to (G_{T}), that verifies the two following properties:

1. Bilinearity:
for all (g₁, g₂)∈(G₁×G₂) and all
(a, b)∈( [symbol] × [symbol] ),
e: G₁×G₂-»G_{T},
e(g₁^{a},g₂^{b})=e(g₁^{b}, g₂^{a})=e(g₁, g₂)^{ab}

2. Non-Degeneracy:
GT is not trivial and if g₁ is a generator of G₁ and g₂ is a generator of G₂ then e(g₁, g₂) is a generator of G_{T}

Weil pairing and Tate pairing are two implementations of an efficient bilinear map over elliptic curve groups useful for cryptography, such as described in Ian F. Blake, Gadiel Seroussi, and Nigel P. Smart, editors, Advances in Elliptic Curve Cryptography, Cambridge University Press, 2005, the contents of which are herein incorporated by reference in its entirety. Cryptographic bilinear maps must have certain complexity properties that are explained in the following section.

### Complexity Assumptions

In general, cryptographic bilinear maps need to be one-way functions, i.e. computing the bilinear pairing should be efficient, but the inverse has to be difficult. The Bilinear Diffie-Hellman (BDH) complexity assumption is related to the difficulty of solving Discrete Logarithm Problem (DLP) over large algebraic groups.

The Diffie Hellman Problem guarantee the security of many schemes in elliptic curves cryptography. The problem is, in a group G of order p, to compute the element (g^{ab}), knowing the group elements g, g^{a} and g^{b} (with a and b random elements in [symbol] ₚ). Precisely, this problem is known as the computational Diffie Hellman Problem.

The Decisional DH Problem is to recognize if an element h is equal to the unknown element gab, knowing the group elements g, g^{a} and g^{b} (with a and b random elements in [symbol] ₚ). It is trivial to see that the Decisional DH problem is easier to solve than the Computational one. Indeed, if an adversary can construct g^{ab} then solving the Decisional problem is straightforward: it computes g^{ab} and compare it to h. Thus, any scheme based on the hardness of the Decisional problem is stronger than one based on the Computational problem.

The Trilinear Computational DH Problem is to compute the element e(g₁, g₂)^{abc} knowing the group elements (g₁, g₂, g₁^{a}, g₂^{a}, g₁^{b}, g₂^{e}) (with a, b, c random elements in [symbol] ₚ). This Problem is harder than the Computational DH problem and is advantageously ensuring the security of the present invention.

### Verifiable Identity Based Encryption (VIBE)

The details of the main algorithms in the VIBE scheme in a preferred embodiment of the present invention, using the bilinear mapping and assumptions provided above, are given as follows:
Setup(λ): It takes as inputs the security parameter λ and then generates the groups G₁, G₂ and G_{T} and a bilinear map e. The size of the groups is determined by λ. Let's denote the identity string of the Trusted Centre by “admin”—note that any other string representing the Trusted Centre, e.g. “abc.com” or “xyz.com” could be used. Select a symmetric key encryption function E in which the shared key is n-bit long. We denote the decryption function corresponding to E by D, and it should be clear that by knowing E it would be easy to find D. Choose four cryptographic hash functions H₁, H₂, H₃, H_{T} such that
H₁{0,1}*→G₁,
H₂: {0,1}*→G₂,
H₃: {0,1}*→ [symbol] *,
H_{T}: G_{T}>{0,1}*
Notations: {0,1}* means a bit string of an arbitrary length, [symbol] * means the set of the non-zero elements of Z (which is the set of relative integers).

Pick at random s∈ [symbol] ₚ* and set g_{admin}=H₁(“admin”)∈G₁. Compute g_{Pub}=g_{admin}^{s} as the Trusted Centre's master public key. Let's denote the public parameters of the VIBE by public parameters (PK) that includes a description of (G₁, G₂, G_{T}, H₁, H₂, H₃, H_{T}, g_{Pub}, ϵ). Set s as the master secret key, which is only known to the Trusted Centre. Output (PK) and s.
Keygen(Id,s): It takes as inputs an identity string of a user (Id) and the secret master key (s) of the administrator. It computes g_{Id}=(H₁(Id),H₂(Id)) and sets the private key of the user as the couple Prv_{Id}=g_{Id}^{s}^{^{−1}}(H₁(Id)^{s}^{^{−1}}, H₂(Id)^{s}^{^{−1}}) (Prv_{Id,1} will be the first element and Prv_{Id,2} the second). It then outputs Prv_{Id}, and privately shares it with the user, for example, over a secure channel. The private key of the user Prv_{Id}, may be shared by any highly secure means, however the VIBE deployment key protocol should be preferred in any cases. Although the private key Prv_{Id} must be kept secure, the public parameters (PK) are very resilient to attacks and can even be sent over an insecure channel and/or be publicly broadcast.

Verifi—Encrypt(Id, PK, M, Prv_{Id}): It takes as inputs the identity string (Id) of the recipient (Id_{Recipient}), the set of public parameters (PK), the plaintext message (M) and the private key of the sender (Prv_{Sender}). The plaintext message (M) is encrypted as follows: The method first verifies the public parameters (PK) are genuine under the chosen Trusted Centre by comparing e (g_{Pub}, Prv_{Sender,2}) with e(H₁(“admin”), H₂(Id_{Sender})). If these values are equal then the public parameters have not been altered and are related to the private keys of the user. If the verification passes, it picks a random symmetric key (Σ) and outputs the encrypted ciphertext (C), where C=(V, U, W, Y) and where V, U, W, Y are computed as follow:

r=H₃(Σ),

i V=g_{Pub}^{r}

U=Σ⊕H_{T}(e(H₁(“admin”),H₂(Id_{Recipient})^{r}))

W=ϵ_{σ}(M)

Y=H_{T}(e(H₁(Id_{Recipient})^{r}, Prv_{Sender,2}))

Auth—Decrypt(Prv_{Recipient}, PK, Id_{Sender}, C): it takes as inputs the private key of the recipient (Prv_{Recipeint}) the public parameters (PK), the identity of the Sender (Id_{Sender}) and the ciphertext (C=(V,U,W,Y)). If the message has been encrypted for the identity (Id_{Recipient}) then the recipient will be able to recover the symmetric key:
Σ=U⊕H_{T}(e(V, Prv_{Recipient,2})).

The plaintext message is recovered by computing M=D_{Σ}(W). Note that (Y) is used to authenticate the sender as follows: The recipient computes r=H₃(Z) and verifies if Y=H_{T}(e(Prv_{Recipient,1}^{r}, H₂(Id_{Sender}))). If it is true the sender is authenticated and the recipient can be sure of who sent the message, if not the sender is rejected.

Verifying the correctness of the scheme: It is easy to check that decryption correctly recovers M. Since ϵ_{Σ} and D_{Σ} have the exact opposite action, thus the recovering of M is equivalent to the recovering of Σ. This is done correctly:

U⊕H_{T}(e(V,Prv_{Recipient,2}))

=U⊕H_{T}(e(g_{Pub}^{r}, g_{Recipient,2}^{s}^{^{−1}}))

=U⊕H_{T}(e(g_{admin}^{s·r},g_{Recipient,2}^{s}^{^{−1}}))

=U⊕H_{T}(e(g_{admin},g_{Recipient,2}^{r·s·s}^{^{−1}})

=U⊕H_{T}(e(g_{admin},g_{Recipient,2})^{r})

=Σ⊕H_{T}(e(H₁(“admin”),H₂(Id_{Recipient})^{r}))⊕H_{T}(e(g_{admin},g_{Recipient,2})^{r})

=Σ

It is also easy to verify that a correctly computed Y will be accepted by the recipient:

Y=H_{T}(e(H₁(Id_{Recipient})^{r}, Prv_{Sender,2}))

Y=H_{T}(e(H₁(Id_{Recipient})^{r},g_{Sender,2}^{s}^{^{−1}}))

Y=H_{T}(e(H₁(Id_{Recipient}),H₂(Id_{Sender}))^{r·s}^{^{−1}})

Y=H_{T}(e(H₁(Id_{Recipient})^{s}^{^{−1}},H₂(Id_{Sender}))^{r})

Y=H_{T}(e(Prv_{Recipient,1},H₂(Id_{Sender}))^{r})

Y=H_{T}(e(Prv_{Recipient,1}^{r},H₂(Id_{Sender})))

As discussed above, the Trusted Centre 20 is configured to initiate the setup of the Verifiable Identity Based Encryption (VIBE) system by running the Setup(λ) algorithm and manage the distribution of private keys (Prv) and public parameters (PK) by Keygen(Id,s) function calls from different users 30 in the network system 10. The Trusted Centre 20 may itself initiate the Setup(λ) algorithm upon startup or when the Trusted Centre 20 determines that it is necessary to renew or reset the security of the network system 10. It can do so by generating a new secret master key (s) and new public parameters (PK). Potential reasons for self-initiation of Setup(λ) are:
security requirements;
policy or regulatory requirements;
application requirements;
   and may be run according to renewal schedules and the like.

Using the mathematical foundation, described above in the preferred embodiments, users 30 in the network system 10 are able to encrypt and decrypt messages using the VIBE scheme.

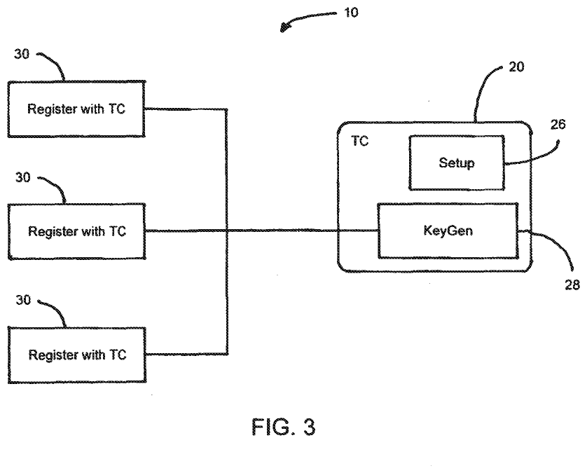

Turning now to FIG. 3, the different users 30 in the network system 10 are operable to register with the Trusted Centre 20 and obtain the public parameters (PK) and their respective private keys (Prv). For example, the users 30 may call the Keygen function 28 made available by the Trusted Centre 20.

The Trusted Centre 20 may also provide a Setup function 26 for a user to call. When called, the Setup function 26 may initiate the Setup(λ) algorithm to renew and/or reset the security of the network system 10 by generating a new secret master key (s) and new public parameters (PK).

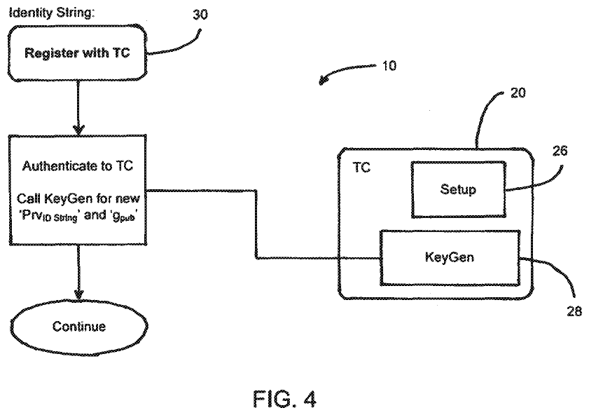

Referring now to FIG. 4, a user 30 is operable to register itself with the Trusted Centre 20 by first authenticating itself with the Trusted Centre 20. Different means for authentication may be used to authenticate a user 30 with the Trusted Centre 20, as known in the art. For example, password-based authentication, a challenge-response protocol such as the Kerberos protocol from the Massachusetts Institute of Technology, biometric authentication (i.e. fingerprint, retinal), and the like may be used. Once the user 30 has authenticated itself, the user 30 is operable to call the Keygen function 28 provided by the Trusted Centre 20 and submitting its identity string (Id) to the Trusted Centre (TC). In FIG. 4, the user 30 is labeled as “Identity String” (e.g. “Id”). The Trusted Centre (TC) then calls the Keygen(Id,$) algorithm using the identity string (Id) provided by the user 30 and its own secret master key (s). In return, the Trusted Centre 20 receives the private key for the user 30 (Prv_{Id}) which the Trusted Centre 20 then passes on to the user 30. The Trusted Centre 20 may also pass on to the user 30, as part of the Keygen function 28, the public parameters (PK).

Another advantageously example would be a registration at the manufacturing process when dealing with connected objects:
inside a chip representing a user 30 with identity (Id), a private key (Prv_{Id}) would be printed. This private key would have been computed using the identity of the chip (Id) and the secret master key (s_{M}) of the manufacturer (M) playing the role of a Trusted Centre;
any real life Trusted Centre (TC) will contact the manufacturer and get a private key (Prv_{TC}) computed using the identity of the Trusted Centre (TC) and the secret master key (s_{M});
user 30 request a private key to the Trusted Centre 20 by sending an authenticated encryption of a request to the Trusted Centre 20 computed using the private key of user 30 (Prv_{Id}), the master public key of the manufacturer (g_{(Pub,M)}) and the identity of the Trusted Centre 20 (TC);
the Trusted Centre 20 computes the private key of the user 30 (Prv_{Id}) using the identity of user 30 (Id) and the secret master key (s_{TC});
the Trusted Centre 20 sends the private key (Prv_{Id}) to user 30 over the secure channel created by the user on his request.

Once the user 30 has its respective private key (Prv) and the public parameters (PK), which includes the master public key of the Trusted Centre (g_{Pub}), a sender is able to send an encrypted message to a recipient without contacting the Trusted Centre 20. No certificate authority is necessary, only the public parameters (PK) and the identity string of the recipient (Id_{Recipient}) is required and guarantee the identity of the recipient.

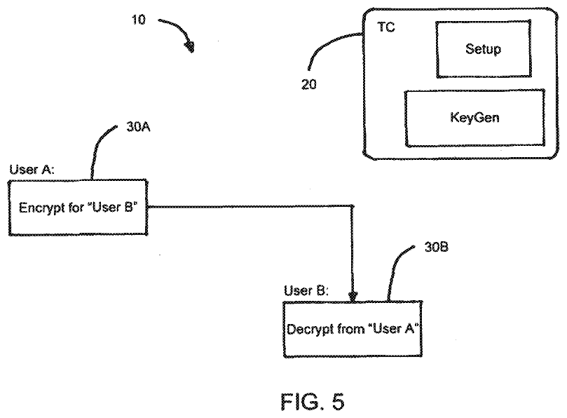

Referring now to FIG. 5, a transmission from a user 30A labeled “User A” to a user 30B labeled “User B” is shown in a preferred embodiment. The transmission of an encrypted message may be completed without contacting the Trusted Centre 20.

In some preferred embodiments, the VIBE scheme of the present invention may not be efficient for encrypting very small messages. In this case (message length less than an AES key length) then the message can be directly encrypted, playing the role of Σ in the encryption algorithm. Note that there will be no W in this ciphertext.

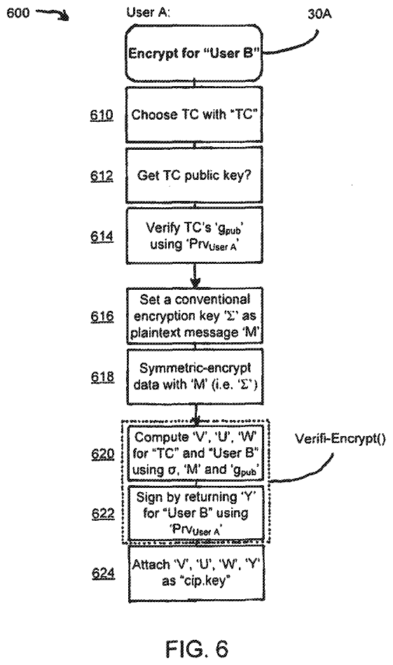

Referring now to FIG. 6, a flowchart 600 is shown illustrating the encryption method of VIBE described before in the algorithm Verifi-Encrypt, used by a user 30A, labeled “User A”, for encrypting a message for a user labeled “User B. In step 610, the sender (i.e. user 30A or “User A”) identifies or chooses a Trusted Centre (TC) to associate the encrypted message with. The sender identifies the Trusted Centre (TC) by its (TC) identity string (Id_{TC}), e.g. label “TC”.

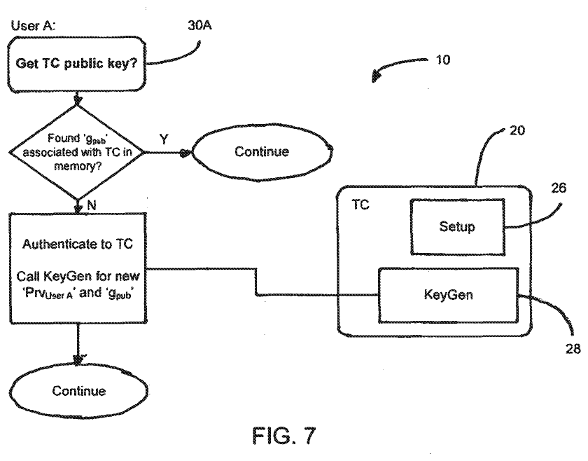

Next, in step 612 the sender determines whether it has the plurality of public parameters (PK) for the Trusted Centre (TC), including the master public key of the Trusted Centre (g_{Pub}) or whether the sender must get the TC's master public key prior to proceeding. Referring briefly to FIG. 7, the sender determines whether or not it needs to get the TC's master public key by comparing whether any of the (g_{Pub}) the sender may have stored in memory is associated with the identity string of the Trusted Centre (Id_{TC}). If not, user 30A authenticates itself with the Trusted Centre 20 and calls the Keygen function to receive its own private key Prv_{UserA} and the Trusted Centre's public parameters (PK), as previously described when registering a new user 30 in FIG. 4.

Returning to FIG. 6, once the sender believes it has the proper master public key (g_{Pub}), the sender in step 614 verifies the TC's public key (g_{Pub}) using the senders private key (Prv_{Sender}) as described above with respect to Verifi-Encrypt(Id,PK,M,Prv_{Sender}) algorithm using the different parameters in the public parameters (PK) associated with the Trusted Centre 20 and the private key of the sender (Prv_{Sender}). As noted above, the TC's master public key (g_{Pub}) and the sender private key (Prv_{Sender}) are fixed values received and stored by the sender from the Trusted Centre (TC). The sender can be assured that the public parameters (PK) have not been tampered with if
e(g_{Pub},Prv_{(Sender,2)}=e(H₁(“admin”) ,H₂(Id_{Sender}))
   is satisfied, as described in the algorithm Verifi-Encrypt(Id,PK,M,Prv_{Sender}).

Once the sender has verified the public parameters (PK), the sender can begin by picking a conventional encryption key (Σ) that is used to encrypt the actual confidential data, such as large documents or video/audio files, using the conventional symmetric encryption scheme (i.e. AES, 3DES and the like). The plaintext message (M) is then set to include the conventional encryption key (Σ) of the conventional symmetric encryption scheme to be protected by the VIBE Verifi-Encrypt( ) algorithm, as shown in step 616. Next, as shown in step 618, the confidential data is symmetrically encrypted using the conventional symmetric encryption scheme and the conventional encryption key (Σ) is stored as (or as a part of) the plaintext message (M).

Next, in step 620, the sender computes each component of the ciphertext (C), as described above with respect to the Verifi-Encrypt(Id,PK,M,Prv_{Sender}) algorithm to symmetrically-encrypt the plaintext message (M) using the symmetric key encryption function (EE), found within the public parameters (PK), and using a random symmetric key (Σ), generated locally by the sender. In particular, each of V, U and W are computed for the particular Trusted Centre (TC) using the recipient identity string (Id_{Recipient} i.e. “User B”) associated with the recipient, the random symmetric key (Σ), which is randomly generated every time Verifi-Encrypt(Id,PK,M,Prv_{Sender}) is run, and the master public key of the Trusted Centre (g_{Pub}), as well as the other public parameters in the public parameters (PK).

In step 622, the encrypted message is signed by returning the ciphertext component Y for the recipient using the sender private key (Prv_{Sender}), or more specifically (Prv_{UserA}). The recipient may be operable to use this ciphertext component Y to authenticate the received message.

Finally, the ciphertext (C) is packaged together in step 624 and is ready to be attached to the transmission to be sent to the recipient. The components of the ciphertext (C) may be packaged as a file (i.e. “cip.key”) or within other methods and/or structures known in the art. The symmetrically-encrypted data using the conventional symmetric encryption scheme along with the file, “cip.key”, containing the conventional encryption key (Σ) stored in the plaintext message (M) is then ready for transmission to the recipient and may be sent over an unsecured channel as a properly encrypted message.

Upon receipt of the ciphertext (C), i.e. as stored in the file “cip.key”, the recipient is operable to decrypt the ciphertext (C) to retrieve the plaintext message (M) that contains the conventional encryption key (Σ) used to encrypt the actual data.

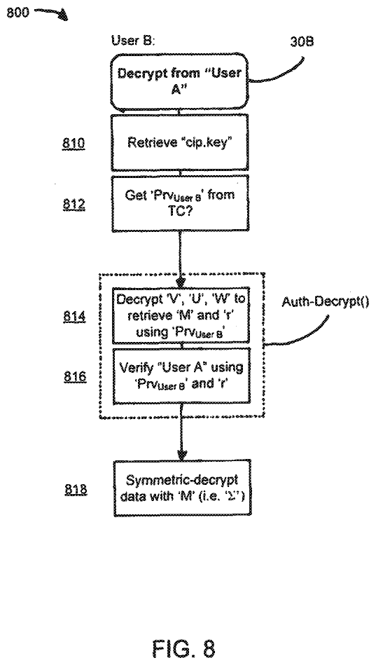

Referring now to FIG. 8, a flowchart 800 is shown illustrating a user 30B, labeled “User B”, decrypting a message from a user labeled “User A. In step 810, the recipient (i.e. user 30B or “User B”) retrieves the ciphertext (C) from the received transmission. For example, the ciphertext (C) may be packaged as the file, “cip.key”.

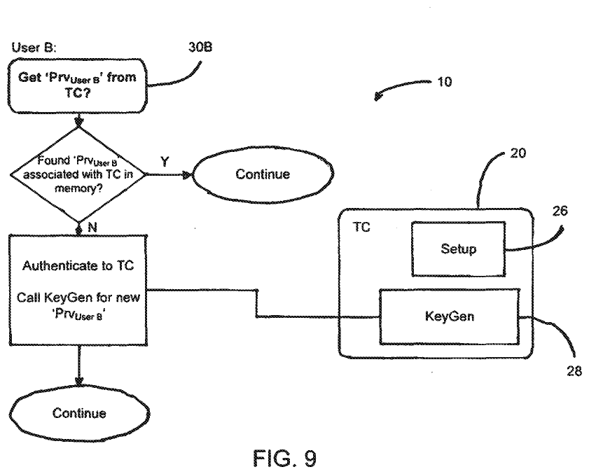

Next, the recipient determines, at step 812, whether it needs to get the recipient private key Prv_{Recipient} (or more specifically Prv_{UserB}) from the Trusted Centre (TC). Referring briefly to FIG. 9, the recipient determines whether or not it needs to get the recipient private key (Prv_{Recipient}) of the particular Trusted Centre (TC) by comparing whether any of the Prv_{UserB} the recipient may have stored in memory is associated with the identity string of the Trusted Centre (Id_{TC}, i-e. “admin”). If not, user 30B authenticates itself with the Trusted Centre 20 and calls the Keygen( ) function to receive its own private key (Prv_{UserB}) and the Trusted Centre's public key (g_{Pub}), as previously described when registering a new user 30 in FIG. 4. At this time, the recipient may also receive an updated set of public parameters (PK) from the Trusted Centre (TC).

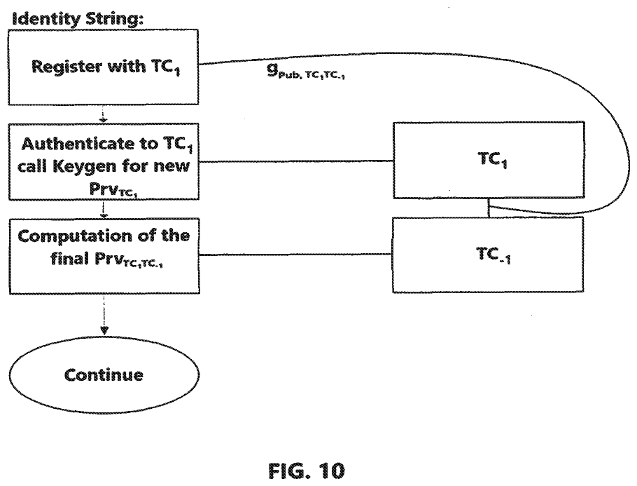

Referring now to FIG. 10, a flowchart is illustrating a method wherein the Trusted Centre (TC) is separated in two Trusted Centre (TC₁) and (TC₍₋₁₎) with master secret key (s₁) and (s₍₋₁₎) and the private keys (Prv_{Id}) are computed through a protocol between the Trusted Centre (TC₁,TC₍₋₁₎) and the user with identity (Id):
at each Trusted Centre (TCᵢ):
   computing Aᵢ=H₁(Id_{TC})^{s}^{ᵢ}, Bᵢ=H₂(Id_{TC})^{s}^{^{−1}}^{ᵢ};
   transmitting privately Aᵢ, Bᵢ to TC₍₋ᵢ₎;
   publishing Aᵢ;
   receiving A₋ᵢ, B₋ᵢ;
   verifying if e(A₋ᵢ, B₋ᵢ)=e(H₁(Id_{TC}), H₂(Id_{TC})) and A₋ᵢ≠H₁(Id_{TC});
   computing the master public key of (TC) as g_{Pub}=A₋ᵢ^{s}^{ᵢ}.
new request of private key, at a Trusted Centre (TCᵢ): if the request from the requestor contains an identifier (Id) identifying the requestor, verifying that this identifier has not been requested, generating a private key (Prv_{Id}) based on the identifier (Id) and the secret master key (sᵢ) and transmitting securely the private key (Prv_{Id}) to the requestor over the network system; All next transmissions do not need to be secured.
at requestor with identity string (Id):
   receiving the private key (Prv_{Id,1}, Prv_{Id,2});
   picking a random number (a) in [symbol] ;
   computing (HPK₁,HPK₂)=(Prv_{Id,1}^{a}^{^{−1}}, Prv_{Id,2}^{a}^{^{−1}}) and T=H₂(Id)^{a}^{^{−1}};
   transmitting (Id,HPK₁,HPK₂,T) to the second Trusted Centre (TC₋ᵢ).
at the second Trusted Centre (TC₋ᵢ):
   identifying the requestor with the identity string (Id);
   verifying that this identifier has not been requested;
   verifying that e(H₁(Id),HPK₂)=e(HPK₁,H₂(Id)) and e(Aᵢ,HPK₂)=e(H₁ (Id_{TC}),T);
   computing (HK₁,HK₂)=(HPK₁^{s}^{_{−1}}^{^{−1}}, HPK₂^{s}^{_{−1}}^{^{−1}});
   transmitting (HK₁,HK₂) to the requestor over the network.
at the requestor:
   receiving (HK₁,HK₂);
   computing Prv_{Id}=(HK₁^{a},HK₂^{a}).

Returning to FIG. 8, the recipient is now able to decrypt the different components V, U and W of the ciphertext (C) using the recipient private key (Prv_{Recipient}) and the public parameters (PK) in step 814. From these components, the recipient is able to retrieve the conventional encryption key (Σ), as described in the Auth-Decrypt(Prv_{Recipient},PK,Id_{Sender},C) algorithm. Furthermore, in step 816, the recipient is operable to verify the sender of the message by inspecting the ciphertext (C) component Y. As described in the Auth-Decrypt(Prv_{Recipient},PK,Id_{Sender},C) algorithm, the sender may be authenticated by calculating H_{T}(e(Prv_{Recipient,1}^{r}, H₂(Id_{Sender}))); User A is authenticated if this value is equal to the received Y.

Finally, once the sender has been verified, the recipient is operable to recover the conventional encryption key (Σ) used by the conventional symmetric encryption scheme to encrypt the confidential data. The plaintext message (M) is recovered using the random symmetric key (Σ) and the symmetric key encryption function (ϵ) to easily determine (D), as described above in the Auth-Decrypt(Prv_{Recipient},PK,Id_{Sender},C) algorithm. Using the conventional encryption key (Σ), the recipient is operable to decrypt the transmitted message using the conventional symmetric encryption scheme. The decryption process is now complete.

The VIBE scheme as described above in a preferred embodiment of the present invention allows for the intended recipient to verify the sender's identity without storing or referring to any public key certificates. If the recipient successfully decrypts the ciphertext (C), the recipient can authenticate the sender based on the properties of the bilinear map (e) using the public parameters (PK) and the sender identity string (Id_{Sender}). The authentication is an integral part of the VIBE scheme and it is more efficient to verify the sender in this manner than separately adding additional authentication components to the encryption process. The VIBE scheme according to the preferred embodiment of the present invention will ensure that not only is the sensitive data kept confidential, but also the sender of the confidential data is authentic. It should be noted that the authentication can be made optional by removing Y from the ciphertext (C) in an application where other authentication/digital signature schemes exist.

### Verifiable Identity-Based Signature (VIBS)

The details of the main algorithms in the signature scheme VIBS in a preferred embodiment of the present invention, using the bilinear mapping and assumptions provided above, are given as follows:

Setup(λ): It takes as inputs the security parameter λ and then generates the groups G₁, G₂ and G_{T} and a bilinear map e. The size of the groups is determined by λ. Denote the identity string of the Trusted Centre by a string, for example “admin”—note that any other string representing the Trusted Centre, e.g. “abc.com” or “xyz.com” could be used. Select a symmetric key encryption function E in which the shared key is n-bit long. Denote the decryption function corresponding to E by D, and it should be clear that by knowing ϵ it would be easy to find D. Choose four cryptographic hash functions H₁, H₂, H₃, H_{T} such that
H₁{0,1}*>G₁,
H₂: {0,1}*>G₂,
H₃: {0,1}*> [symbol] *,
H_{T}: G_{T}>{0,1}*
Notations: {0,1}* means a bit string of an arbitrary length, [symbol] * means the set of the non-zero elements of [symbol] (which is the set of relative integers).

Pick at random s∈ [symbol] ₚ* and set g_{admin}=H₁(“admin”)∈G₁. Compute G_{Pub}=g_{admin}^{s} as the Trusted Centre's master public key. Denote the public parameters of the VIBE by public parameters (PK) that includes a description of (G₁, G₂, G_{T}, H₁, H₂, H₃, H_{T}, g_{Pub}, ϵ). Set s as the master secret key, which is only known to the Trusted Centre. Output (PK) and s.

Keygen(Id,s): It takes as inputs an identity string of a user (Id) and the secret master key (s) of the administrator. It computes g_{Id}=(H₁(Id),H₂(Id)) and sets the private key of the user as the couple Prv_{Id}=g_{Id}^{s}^{^{−1}}=(H₁(Id)^{s}^{^{−1}}, H₂(Id)^{s}^{^{−1}}) (Prv_{Id,1} will be the first element and Prv_{Id,2} the second). It then outputs Prv_{Id}, and privately shares it with the user, for example, over a secure channel The private key of the user Prv_{Id} may be shared by any highly secure means, however the VIBE deployment key protocol should be preferred in any cases. Although the private key Prv_{Id} must be kept secure, the public parameters (PK) are very resilient to attacks and can even be sent over an insecure channel and/or be publicly broadcast.

Sign(Id_{Sender}), PK, m, Prv_{Id}_{_{Sender}}): It takes as inputs the identity string of the sender (Id_{Sender}), the set of public parameters (PK), the plaintext message (M) (or a ciphertext message) and the private key of the sender (Prv_{Sender}). It picks a random big number a different from 0 and 1 and outputs the signature σ. Where σ=(σ₁, σ₂, σ₃) and where σ₁, σ₂, σ₃ are computed as follow:

$${σ}_{1} = {Prv}_{Sender , 2}^{\frac{1}{{H}_{3} ( m ) + α}} , \\ {σ}_{2} = {g}_{P u b}^{α} , \\ {σ}_{3} = P r {v}_{S e n der , 2}^{{α}^{- 1}} .$$

Verify(Id_{Sender}, PK, σ): It takes as inputs the identity string of the sender (Id_{Sender}), the set of public parameters (PK), the signature on the message (σ) and the plaintext (or ciphertext) message (m). The verification of the signature is achieved by verifying the validity of the two following equalities (3 pairings needed only):

e(σ₂,σ₃)=e(H₁(Id_{TC}),H₂(Id_{Sender})),

e(g_{Pub}^{H}^{₃}^{(m)}·σ₂,σ₁)=e(H₁(Id_{TC}), H₂(Id_{Sender}))

Verifying the correctness of the scheme: It is easy to check that the verification of a correctly computed signature verifies:

$$e ( {σ}_{2} , {σ}_{3} ) = e ( {g}_{Pub}^{α} , {Prv}_{S e n der , 2}^{{α}^{- 1}} ) = {e ( {g}_{Pub} , {Prv}_{Sender , 2} )}^{{α}^{- 1} \cdot α} = e ( {g}_{Pub} , {Prv}_{Sender , 2} ) = e ( {{H}_{1} ( I {d}_{T C} )}^{s} , {{H}_{2} ( I {d}_{S e n d e r} )}^{{s}^{- 1}} ) = {e ( {H}_{1} ( I {d}_{T C} ) , {H}_{2} ( I {d}_{S e n d e r} ) )}^{s \cdot {s}^{- 1}} = e ( {H}_{1} ( I {d}_{T C} ) , {H}_{2} ( I {d}_{S e n d e r} ) )$$

### And:

$$e ( {g}_{Pub}^{{H}_{3} ( m )} \cdot {σ}_{2} , {σ}_{1} ) = e ( {g}_{Pub}^{{H}_{3} ( m )} \cdot {g}_{Pub}^{α} , {Prv}_{Sender , 2}^{\frac{1}{{H}_{3} ( m ) + α}} ) = {e ( {g}_{Pub}^{{H}_{3} ( m ) + α} , {H}_{2} ( I {d}_{S e n d e r} ) )}^{\frac{s - 1}{{H}_{3} ( m ) + α}} = {e ( {{H}_{1} ( I {d}_{T C} )}^{s ( {H}_{3} ( m ) + α )} , {H}_{2} ( I {d}_{S e n d e r} ) )}^{\frac{s - 1}{{H}_{3} ( m ) + α}} = {e ( {H}_{1} ( I {d}_{T C} ) , {H}_{2} ( I {d}_{S e n d e r} ) )}^{\frac{s \cdot {s}^{- 1} ( {H}_{3} ( m ) + α )}{{H}_{3} ( m ) + α}} = e ( {H}_{1} ( I {d}_{T C} ) , {H}_{2} ( I {d}_{S e n d e r} ) )$$

The algorithms Setup and Keygen are the same in VIBE and VIBS enabling the use of both with the same public parameters and private keys.

### Dynamic Authority

The encryption key in VIBE scheme according to the preferred embodiment of the present invention is derived from dynamic parameters that are calculated from the Trusted Centre's identifier, e.g. domain name, phone number, etc.

This new design yields greater flexibility in working with multiple authorities. The sender of encrypted data can enforce elaborate access conditions on the recipient before the recipient can decrypt and retrieve sensitive data. The sender can select not only who the recipient is but also how the recipient receives its private key (Prv_{Recipient}). For example, a descriptive string may be combined or appended with the TC identity string (Id_{TC}c) to increase the level of authentication required by the Trusted Centre (TC) necessary for the recipient to obtain its private key (Prv_{Recipient}) from the Trusted Centre (TC). The recipient may be forced by the Trusted Centre (TC) to further authenticate itself by satisfying this additional condition, provided by the descriptive string. The additional descriptive string may include the recipient's role, the recipient's revocation number, the recipient's age, the recipient's location, an expiry date and the like.

As an example, the sender can choose “bob@ abc.com” as the recipient's identity of the encrypted message and can set “abc.com-date” as the Trusted Centre's public identity string (TC_{Id}) with an expiry date “date”. The sender's description of the TC identity string (TC_{Id}) is then enforced in the ciphertext (C) by locally computing a new g_{(Admin-New)} where g_{(Admin-New)}=H₁(“abc.com-date”). If the sender possesses the master public key of the Trusted Centre (TC) g_{Pub}=g_{Admin-New}^{s} it can proceed with Verifi-Encrypt( ) as described above. Otherwise, the sender is forced to obtain a new g_{Pub}, as shown with respect to FIG. 7.

Beyond this date, the encryption algorithm would receive a new public key from the Trusted Centre (TC) and would use it to generate new encryption keys. The recipient would then be forced to renew its private key from Trusted Centre. This is very useful in conditions where the identity of users in the system will remain the same for an extended period, but it is beneficial for security reasons to have the private keys update periodically and/or frequently. On the receiver's side, if the same secret master key (s) is used to compute the new master public key of the Trusted Centre (TC) no change has to be made to the private key of the recipient (Prv_{Recipient}) or the decryption algorithm. If, however, a different secret master key (s) is used, the recipient will be forced to receive a new private key corresponding to the secret master key of the Trusted Centre (TC) with the new TC identity string (Id_{TC}), as shown in FIG. 9.

It should be noted that the same encryption algorithm can be used if the sender decides to use a different server (trusted authority) such as “xyz.com” instead of “abc.com”. The only difference in the encryption algorithm would be in using the master public key of the new Trusted Centre (g(Pub-New)) everything else remains the same.

### Revocation and Rekeying

This design using identity string can also be used on the user side allowing for example rekeying: an arbitrary sized revocation number (RevNum) can be appended on identity string (Id) representing the identity of the user: (Id∥RevNum). This method advantageously allows any user to renew his key as followed:
Any private key (Prv) that is requested for the new identity (Id) is computed using the hash of the identity (Id∥0).
When a user with identity string (Id) request a rekeying to the Trusted Centre (TC), the Trusted Centre search for this identity string (Id) in the revocation list (RL) and extract the revocation number attached to it (RevNum_{Id}).
The Trusted Centre (TC) securely transmit the new private key (Prv_{(Id|RevNumId+2)}) computed using the secret master key (s), the identity string of the requestor (Id) and the revocation number increased by 2 (RevNum_{Id}+2).
The Trusted Centre (TC) register the new revocation number (RevNum_{Id}+1) along with the identity of the requestor (Id) in the revocation list (RL).
The Trusted Centre publish the new revocation list (RL).

The same method can advantageously be used to do simple revocation: a revocation number is appended on identity string representing the identity of the user: (Id∥RevNum). This method advantageously allows any user to be revoked through the following method:
When a user with identity string (Id) request a revocation to the Trusted Centre (TC), the Trusted Centre search for this identity string (Id) in the revocation list (RL) and extract the revocation number attached to it (RevNum_{Id}).
The Trusted Centre (TC) register the new revocation number (RevNum_{Id}+1) along with the identity of the requestor (Id) in the revocation list (RL).
The Trusted Centre publish the new revocation list (RL).

### Exchange of Trust

As discussed above, the VIBE scheme according to the present invention allows the sender to communicate privately with any recipient under various trusted authorities. For example, the sender can send an encrypted message from the “abc.com” domain (with secret master key s) to someone in the “xyz.com” domain (with secret master key s′). As long as any new Trusted Centre (TC″) register to the first Trusted Centre (TC) and owns a private key (Prv_{TC}), any user can get a private key (Prv′) for the domain of (TC″) advantageously as follow:
The user with identity (Id) sends an encrypted and authenticated message to (TC′) using the private key (Prv_{Id}), the identity of the second Trusted Centre (Id_{TC}), and a private key request as plaintext message (M).
Once this request received and the validity of the user's identity is verified the second Trusted Centre (TC″) compute a private key (Prv'_{Id}) using the secret master key (s′), and the identity string of the user (Id).
The second Trusted Centre (TC′) sends an authenticated ciphertext (C) encrypted using the master public key of the first Trusted Centre (TC), the identity of the user (Id), the sender's private key (Pr_{TC′}) and the freshly computed private key (Prv′) as plaintext message (M).
At reception of the ciphertext (C), the user decrypts and verify the identity of the sender using the receiver private key (Prv_{Id}) and the identity string of the sender (Id_{TC}).

In this manner, the sender has control of which Trusted Centre (TC) to associate with and can force the recipient to authenticate to a Trusted Centre (TC) of its choosing. Accordingly, the sender can rely on the additional security of choosing its preferred Trusted Centre to generate and supply the private key (Prv) to the recipient. The onus can then be placed on the recipient to associate with reliable Trusted Centers and authenticate itself to the Trusted Centre (TC), selected by the sender, to receive the private key for the recipient (Prv_{Recipient})

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein. The scope of the claims should not be limited to the preferred embodiments set forth in the examples, but should be given the broadest interpretation consistent with the description as a whole.

It will be understood that, although various features of the invention have been described with respect to one or another of the embodiments of the invention, the various features and embodiments of the invention may be combined or used in conjunction with other features and embodiments of the invention as described and illustrated herein. Furthermore, while the various methods described herein may refer to a specific order and number of steps, it should be understood that the order and/or number of method steps described herein should not be construed as limiting, as other orders and/or number of steps would be understood by persons skilled in the art.

The embodiments of the invention in which an exclusive property or privilege is claimed is defined as stated in the claims.

What is claimed is:

1-21. (canceled)

22. A method of sending an encrypted message, by a sender having a sender identity string, to a recipient over a network using Identity-Based Encryption, the method comprising:
identifying a Trusted Centre (TC) by a TC identity string (Id_{TC}), the Trusted Centre having a master public key of the Trusted Centre (g_{Pub}) based on the TC identity string (Id_{TC});
determining if the sender has a sender private key Prv_{Sender} and a plurality of public parameters (PK) for the Trusted Centre (TC), the public parameters (PK) including the master public key of the Trusted Centre (g_{Pub}) and a bilinear map (e);
verifying the public parameters (PK) of the Trusted Centre (TC) using the TC identity string (Id_{TC}) prior to encrypting a plaintext message (M);
identifying the recipient by a recipient identity string (Id_{Recipient});
hashing the identity string of the recipient (Id_{Recipient}) using cryptographic hash functions (H₁,H₂,H₃,H_{T}) lying in the public parameters (PK), encrypting the plaintext message (M) as ciphertext (C) using the public parameters (PK), a random symmetric key (Σ) and the hash of the identity string of the recipient (Id_{Recipient}), and transmitting the ciphertext (C) to the recipient over the network, wherein a plaintext or a ciphertext is signed for any user attesting the origin of the message using the public parameters (PK) of the Identity-Based Encryption, which can be verified by any user.

23. The method of claim 22, wherein verifying the public parameters (PK) comprises comparing values of the bilinear map (e) calculated with variables comprising the sender private key (Prv_{Sender}) and the master public key of the Trusted Centre (g_{Pub}).

24. The method of claim 22, wherein the public parameters (PK) are verified if: e(g_{Pub},Prv_{(Sender,2)})=e(H₁(Id_{TC}),H₂(Id_{Sender})).

25. The method of claim 22, wherein the sender private key Prv_{Sender} and master public key of the Trusted Centre (g_{Pub}) are provided by the Trusted Centre (TC).

26. The method of claim 22, wherein the Trusted Centre (TC) is separated in a plurality of Trusted Centers avoiding any key escrow.

27. The method of claim 22, wherein the Trusted Centre (TC) is separated in two Trusted Centre (TC₁) and (TC₍₋₁₎) with master secret key (s₁) and (s₍₋₁₎) and the private keys (Prv_{Id}) are computed through a protocol between the Trusted Centre (TC₁,TC₍₋₁₎) and the user with identity (Id) as followed:
at each Trusted Centre (TCᵢ):
computing Aᵢ=H₁(Id_{TC})^{s}^{ᵢ}, Bᵢ=H₂(Id_{TC})^{s}^{ᵢ}⁻¹;
transmitting privately Aᵢ, Bᵢ to TC₋ᵢ;
publishing Aᵢ;
receiving A₋ᵢ, B₋ᵢ;
verifying if e(A₋ᵢ, B₋ᵢ)=e(H₁(Id_{TC}), H₂(Id_{TC})) and A₋ᵢ≠H₁(Id_{TC});
computing the master public key of (TC) as g_{Pub}=A₋ᵢ^{s}^{ᵢ}; and
new request of private key, at a Trusted Centre (TCᵢ): if the request from the requestor contains an identifier (Id) identifying the requestor, verifying that this identifier has not been requested, generating a private key (Prv_{Id}) based on the identifier (Id) and the secret master key (sᵢ) and transmitting securely the private key (Prv_{Id}) to the requestor over the network system; whereby all next transmissions preferably does not need to be secured; and
at requestor with identity string (Id):
receiving the private key (Prv_{Id,1}, Prv_{Id,2});
picking a random number (a) in Z;
computing (HPK₁, HPK₂)=(Prv_{Id,1}^{a}^{^{−1}}, Prv_{Id,2}^{a}^{^{−1}}) and T=H₂(Id)^{a}^{^{−1}};
transmitting (Id, HPK₁, HPK₂, T) to the second Trusted Centre (TC₋ᵢ); and
at the second Trusted Centre (TC₋ᵢ):
identifying the requestor with the identity string (Id);
verifying that this identifier has not been requested;
verifying that e(H₁(Id), HPK₂)=e(HPK₁, H₂(Id)) and e(Aᵢ, HPK₂)=e(H₁(Id_{TC}), T);
computing (HK₁, HK₂)=(HPK₁^{s}^{_{−1}}^{^{−1}}, HPK₂^{s}^{_{−1}}^{^{−1}});
transmitting (HK₁, HK₂) to the requestor over the network; and
at the requestor:
receiving (HK₁, HK₂);
computing Prv_{Id}=(HK₁^{α}, HK₂^{α}).

28. The method of claim 22, wherein the public parameters (PK) further include a description of the groups (G₁,G₂,G_{T}), a description of the cryptographic hash functions (H₁,H₂,H₃,H_{T}), a symmetric key encryption function (E), and a description of the bilinear map (also called pairing) (e) which takes as input one element from (G₁) and one element of (G₂) and output an element from (G_{T}) and that verifies the properties of a non-degenerated bilinear map.

29. The method of claim 22, wherein the ciphertext (C) includes an authentication component (Y) for authenticating the sender once the ciphertext (C) is received by the recipient.

30. The method of claim 29, wherein the authentication component (Y) is based on the sender private key (Prv_{Sender}) and the identity string of the recipient (Id_{Recipient}), and wherein preferably the recipient is operable to verify the sender using the public parameters (PK), the sender identity string (Id_{Sender}) and a recipient private key (Prv_{Recipient}) obtained from the Trusted Centre (TC).

31. The method of claim 22, wherein the signature σ is computed using the sender private key (Prv_{Sender}), the identity of the sender (Id_{Sender}) and wherein preferably the verifier is operable to verify the signature using the public parameters (PK), the sender identity string (Id_{Sender}) and the Trusted Centre identity (Id_{TC}).

32. The method of claim 22, wherein the sender can specify an expiry date for the master public key of the Trusted Centre (g_{Pub}), whereby after the expiry date, the recipient is forced to authenticate with the Trusted Centre (TC) to obtain a new recipient private key (Prv_{Recipient}).

33. The method of claim 22, wherein the sender can specify a descriptive string to append to the TC identity string (Id_{TC}), whereby the descriptive string is used by the Trusted Centre (TC) to require additional levels of authentication from the recipient in order for the Trusted Centre (TC) to provide a recipient private key (Prv_{Recipient}) to the recipient.

34. The method of claim 33, wherein the descriptive string is selected from the group consisting of: a revocation number, a role of the recipient, an age of the recipient, a location of the recipient and/or an expiry date.

35. The method of claim 22, wherein for encryption, the plaintext message (M) is a conventional encryption key for encryption.

36. A method for using verifiable identity-based encryption (VIBE) in a network system between a sender having a sender identity string (Id_{Sender}) and a recipient having a recipient identity string (Id_{Recipient}), the method comprising:
at the sender:
identifying a Trusted Centre (TC) by a TC identity string (Id_{TC}), the Trusted Centre having a master public key of the Trusted Centre (g_{Pub}) based on the Trusted Centre identity string (Id_{TC});
determining if the sender has a sender private key (Prv_{Sender}) and a plurality of public parameters (PK) for the Trusted Centre (TC), the public parameters (PK) including the master public key (g_{Pub}) of the Trusted Centre (TC) and a bilinear map (e);
verifying the public parameters (PK) of the Trusted Centre (TC) using the Trusted Centre identity string (Id_{TC}) prior to encrypting a plaintext message (M);
identifying the recipient by an identity string (Id_{Recipient});
hashing the identity string of the recipient (Id_{Recipient}) using cryptographic hash functions (H₁,H₂,H₃,H_{T}) lying in the public parameters (PK);
encrypting the plaintext message (M) as ciphertext (C) using the public parameters (PK), a random symmetric key (Σ) and the hash of the identity string of the recipient (Id_{Recipient});
transmitting (C) to the recipient over the network; and/or
at the recipient:
receiving the ciphertext (C) from the sender over the network system;
determining if the recipient has a recipient private key (Prv_{Recipient}) and the public parameters (PK) for the Trusted Centre (TC);
decrypting the first part of the ciphertext (C) (e.g. U, V) to obtain the symmetric key (Σ) using the public parameters (PK) and the recipient private key (Prv_{Recipient});
decrypting the second part of the ciphertext (C) (e.g. W the same as in the algorithm Auth-Decrypt) to obtain the plaintext message (M) using the decryption algorithm (ϵ) and the symmetric key (Σ),
wherein a plaintext or a ciphertext is signed for any user attesting the origin of the message using the public parameters (PK) of the Identity-Based Encryption, which can be verified by any user.

37. The method of claim 36, wherein the method further comprises, at the recipient, verifying the identity of the sender using the ciphertext (C), the public parameters (PK), the sender identity string (Id_{Sender}) and the recipient private key (Prv_{Recipient}).

38. A method of verifying a plurality of public parameters (PK) from a Trusted Centre (TC) in an identity based encryption system prior to encrypting a plaintext message (M) by a sender having a sender identity string (Id_{Sender}), the method comprising:
identifying the Trusted Centre (TC) by a Trusted Centre identity string (Id_{TC}), the Trusted Centre having a master public key (g_{Pub}) based on the Trusted Centre identity string (Id_{TC});
determining if the sender has a sender private key (Prv_{Sender}) and the plurality of public parameters (PK) for the Trusted Centre (TC), the public parameters (PK) including the master public key of the Trusted Centre (g_{Pub}) and a bilinear map (e);
verifying the public parameters (PK) of the Trusted Centre (TC) using the Trusted Centre identity string (Id_{TC}) prior to encrypting the plaintext message (M) by comparing values of the bilinear map (e) calculated with variables comprising the sender private key (Prv_{Sender}) and the master public key of the Trusted Centre (g_{Pub}),
wherein a plaintext or a ciphertext is signed for any user attesting the origin of the message using the public parameters (PK) of the Identity-Based Encryption, which can be verified by any user.

39. A system for sending an encrypted message over a network using Identity-Based Encryption, the system comprising:
a Trusted Centre (TC) having a Trusted Centre identity string (Id_{TC}), a sender having a sender identity string (Id_{Sender}), and a recipient having a recipient identity string (Id_{Recipient});
wherein the Trusted Centre (TC) has a first memory and one or more configured for:
generating a plurality of public parameters (PK) and a secret master key (s) from a security parameter (λ), the public parameters (PK) including a bilinear map (e) and a master public key of the Trusted Centre (g_{Pub}) based on the Trusted Centre identity string (Id_{TC});
receiving a request from a requestor;
if the request from the requestor contains an identifier (Id) identifying the requestor, generating a private key (Prv_{Id}) based on the identifier (Id) and the secret master key (s) and transmitting the private key (Prv_{Id}) to the requestor over the network system;
if the request from the requestor includes a request for the public parameters (PK), transmitting the public parameters (PK) to the requestor over the network system;
wherein the sender has a second memory and one or more processors configured for:
identifying the Trusted Centre (TC) by the Trusted Centre identity string (Id_{TC});
determining if the sender has a sender private key (Prv_{Sender}) and the public parameters (PK) for the Trusted Centre (TC);
verifying the public parameters (PK) of the Trusted Centre (TC) using the Trusted Centre identity string (Id_{TC}) prior to encrypting a plaintext message (M);
identifying the recipient by the recipient identity string (Id_{Recipient});
hashing the identity string of the recipient (Id_{Recipient}) using cryptographic hash functions (H₁,H₂,H₃,H_{T}) lying in the public parameters (PK);
encrypting the plaintext message (M) as ciphertext (C) using the public parameters (PK), a random symmetric key (λ) and the hash of the identity string of the recipient (Id_{Recipient});
transmitting (C) to the recipient over the network;
wherein the recipient has a third memory and one or more processors configured for:
receiving the ciphertext (C) from the sender over the network system;
determining if the recipient has a recipient private key Prv_{Recipient} and the public parameters (PK) for the Trusted Centre (TC);
decrypting the first part of the ciphertext (C) (e.g. U, V) to obtain the symmetric key (Σ) using the public parameters (PK) and the recipient private key (Prv_{Recipient});
decrypting the second part of the ciphertext (C) (e.g. W) to obtain the plaintext message (M) using the decryption algorithm (ϵ) and the symmetric key (Σ),
wherein a plaintext or a ciphertext is signed for any user attesting the origin of the message using the public parameters (PK) of the Identity-Based Encryption, which can be verified by any user.

40. The system of claim 39, wherein preferably the plurality of public parameters (PK) further include a description of the groups (G₁, G₂, G_{T}), a description of the cryptographic hash functions (H₁, H₂, H₃, H_{T}), a symmetric key encryption function (ϵ), and a description of the bilinear map (also called pairing) (e) which takes as input one element from (G₁) and one element of (G₂) and output an element from (G_{T}) and that verifies the properties of a non-degenerated bilinear map.

41. A computer program product comprising a computer readable memory storing computer executable instructions thereon that, when executed by a computer, perform the method steps of:
identifying a Trusted Centre (TC) by a TC identity string (Id_{TC}), the Trusted Centre having a master public (g_{Pub}) based on the TC identity string (Id_{TC});
determining if a sender has a sender private key (Prv_{Sender}) and a plurality of public parameters (PK) for the Trusted Centre (TC), the public parameters (PK) including the master public key of the Trusted Centre (g_{Pub}) and a bilinear map (e);
verifying the public parameters (PK) of the Trusted Centre (TC) using the Trusted Centre identity string (Id_{TC}) prior to encrypting a plaintext message (M);
identifying a recipient by a recipient identity string (Id_{Recipient});
hashing the identity of the recipient (Id_{Recipient});
encrypting the plaintext message (M) as ciphertext (C) using the public parameters (PK) a random symmetric key (Σ) and the hash of the identity of the recipient;
transmitting the ciphertext (C) to the recipient over a network,
wherein a plaintext or a ciphertext is signed for any user attesting the origin of the message using the public parameters (PK) of the Identity-Based Encryption, which can be verified by any user.
